(19) United States
(12) Patent Application Publication
(10) Pub. No.: US 2024/0378688 A1
(43) Pub. Date: Nov. 14, 2024

(54) METHODS AND SYSTEMS FOR GENERATING RECOMMENDATIONS FOR ACTIONS TO IMPROVE NON-COGNITIVE METRICS IMPACTING REQUIREMENT COMPLETION

(71) Applicants: John Stevens, Grantham, NH (US); Rachel Pauletti, Jupiter, FL (US); Ryne Sherman, Tulsa, OK (US)

(72) Inventors: John Stevens, Grantham, NH (US); Rachel Pauletti, Jupiter, FL (US); Ryne Sherman, Tulsa, OK (US)

(21) Appl. No.: 18/661,166

(22) Filed: May 10, 2024

Related U.S. Application Data
(60) Provisional application No. 63/465,463, filed on May 10, 2023.

(51) Int. Cl. G06Q 50/20

(52) U.S. Cl. CPC G06Q 50/2053

(57) ABSTRACT

A method for generating recommendations for actions to be executed to improve non-cognitive metrics impacting likelihood of requirement completion includes executing, by a computing device, an assessment tool for assessing at least one non-cognitive variable of an applicant. The method includes identifying, by an analysis engine executed by the computing device, at least one risk factor for non-persistence by the applicant. The method includes identifying, by the analysis engine, a likelihood of success by the applicant in completing at least one requirement of an educational institution. The method includes identifying, by the analysis engine, at least one action to recommend for execution, execution of the at least one action satisfying a threshold level of likelihood of improving the likelihood of success. The method includes providing, by the analysis engine, to the educational institution, the identified at least one action.

### CROSS-REFERENCE TO RELATED APPLICATIONS

This application claims priority from U.S. Provisional Patent Application Ser. No. 63/465,463, filed on May 10, 2023, entitled “Methods and Systems for Generating Recommendations for Actions to Improve Non-Cognitive Metrics Impacting Requirement Completion,” which is hereby incorporated by reference.

### BACKGROUND

The disclosure relates to methods for assessing non-cognitive metrics and generating recommendations for actions to be executed to improve those non-cognitive metrics impacting likelihood of requirement completion. More particularly, the methods and systems described herein relate to functionality for executing assessment tools for assessing non-cognitive variables associated with applicants to educational institutions and generating recommendations for actions for execution by the applicant to improve a likelihood of completion of a requirement of an educational institution by the applicant.

Conventionally, educational institutions evaluate cognitive metrics to determine whether to accept an applicant to an educational program provided by the educational institution. However, such cognitive metrics alone do not typically predict whether the applicant will succeed in completing the educational program. Therefore, there is a need for a technological solution to the problem of assessing non-cognitive variables and identifying actions to be taken by the applicant that are likely to improve the likelihood of success in completing the educational program.

### BRIEF SUMMARY

In one aspect, a method for generating recommendations for actions to be executed to improve non-cognitive metrics impacting likelihood of requirement completion includes executing, by a computing device, an assessment tool for assessing at least one non-cognitive variable of an applicant. The method includes identifying, by an analysis engine executed by the computing device, at least one risk factor for non-persistence by the applicant. The method includes identifying, by the analysis engine, a likelihood of success by the applicant in completing at least one requirement of an educational institution. The method includes identifying, by the analysis engine, at least one action to recommend for execution, execution of the at least one action satisfying a threshold level of likelihood of improving the likelihood of success. The method includes providing, by the analysis engine, to the educational institution, the identified at least one action.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a flow diagram depicting an embodiment of a method for generating recommendations for actions to improve non-cognitive metrics impacting requirement completion; and

FIG. 2 is a block diagram depicting an embodiment of a system for generating recommendations for actions to improve non-cognitive metrics impacting requirement completion.

### DETAILED DESCRIPTION

The methods and systems described herein may provide functionality for generating recommendations for actions to improve non-cognitive metrics impacting requirement completion.

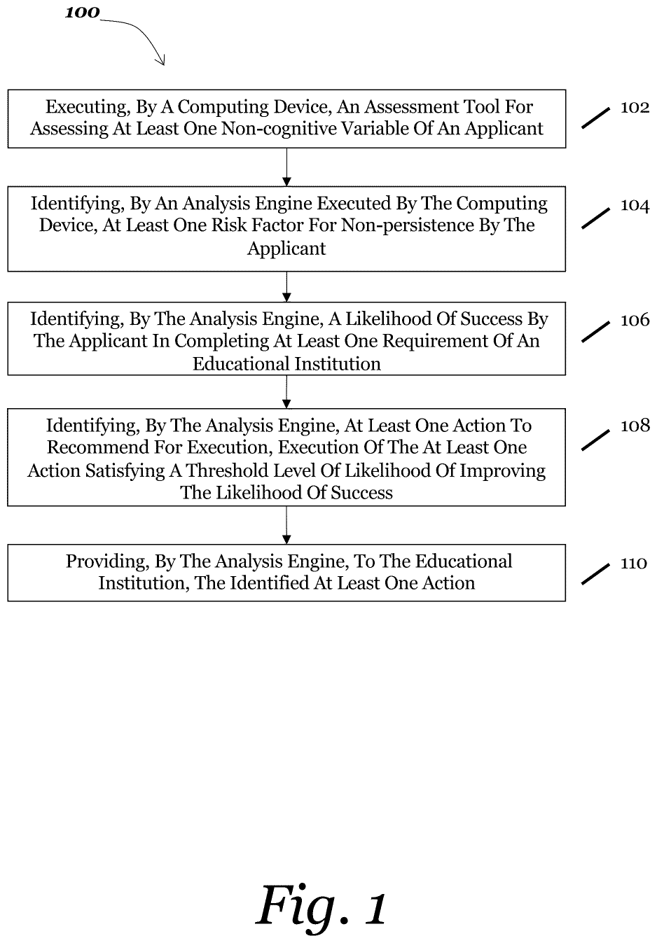

Referring now to FIG. 1, in brief overview, a block diagram depicts one embodiment of a method 100 for generating recommendations for actions to improve non-cognitive metrics impacting requirement completion. The method 100 includes executing, by a computing device, an assessment tool for assessing at least one non-cognitive variable of an applicant (102). The method 100 includes identifying, by an analysis engine executed by the computing device, at least one risk factor for non-persistence by the applicant (104). The method 100 includes identifying, by the analysis engine, a likelihood of success by the applicant in completing at least one requirement of an educational institution (106). The method 100 includes identifying, by the analysis engine, at least one action to recommend for execution, execution of the at least one action satisfying a threshold level of likelihood of improving the likelihood of success (108). The method 100 includes providing, by the analysis engine, to the educational institution, the identified at least one action (110).

As will be understood by those of skill in the art, cognitive skills include, without limitation, quantitative skills, writing skills, verbal ability, vocabulary, hard skills, and metrics of intelligence. Admissions processes typically focus on identifying applicants that have both high cognitive ability and high non-cognitive ability but often rely upon standardized tests that identify applicants with high cognitive ability, typically without regard for the applicants' non-cognitive attributes. Non-cognitive abilities include, by way of example and without limitation, personality, character, identity, virtue, self-concept, soft skills, adjustment (e.g., composure, optimism, mood stability), ambition (e.g., initiative, competition, leadership ability), sociability (e.g., extroversion or introversion), interpersonal sensitivity (e.g., conscientiousness, dependability, ability to abide by rules), inquisitiveness (e.g., curiosity, imagination, vision, tolerance of boredom), learning approach (e.g., learning style, learning differences, ability to pursue and/or enjoy formal education) and other personal attributes. By assessing an applicant's non-cognitive abilities as well as cognitive abilities, an application process may assess a likelihood of success of an applicant in an educational program. However, that likelihood of success may be impacted by one or more risk factors of the applicant, related to the non-cognitive attributes, and may or may not be fixed. Although non-cognitive variables may act as reliable predictors of applicant outcomes (including, without limitation, academic performance, likelihood of success in completing one or more educational programs, salary, promotions, career satisfaction, burnout, interpersonal conflict levels, types of peer relationships, and overall health), and may possibly act as more reliable predictors than cognitive variables conventional approaches to assessing applicants to educational institutions typically lack functionality for assessing those non-cognitive variables. The methods and systems described herein provide technological tools to solve the technological problem of receiving assessment data identifying an applicant and needing an automated solution for identifying one or more risk factors of the applicant and one or more actions that could be taken by the applicant to mitigate the impact of those identified risk factors on the applicant's likelihood of success in an educational program.

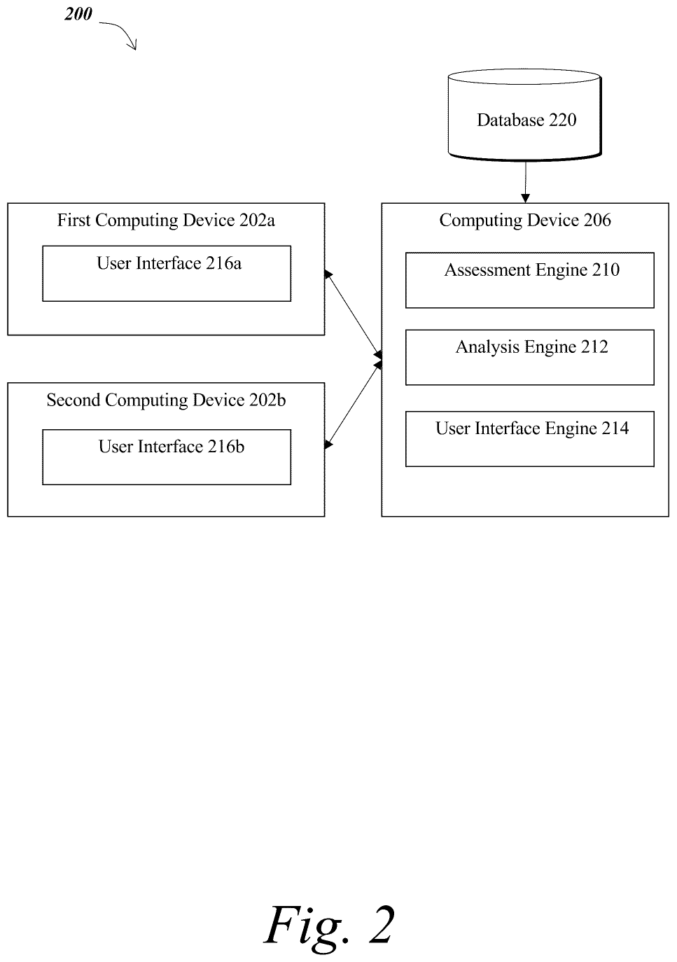

Referring now to FIG. 1, in greater detail and in connection with FIG. 2, the method 100 includes executing, by a computing device, an assessment tool for assessing at least one non-cognitive variable of an applicant (102). The computing device 206 may execute the assessment tool. For example, the computing device 206 may execute an assessment engine 210 that, in communication with a user interface engine 214, provides one or more questions and receives one or more responses from an applicant to an educational institution.

The assessment tool may include one or more questions based upon applied people analytics and psychological science. The assessment tool may include one or more questions designed to generate responses that may be used to identify risk factors for non-persistence based on non-cognitive factors. The assessment tool may include, by way of example and without limitation, a range of questions which may, in one embodiment, be 50-100 questions. The assessment tool may include questions that can be answered in a specific time period, such as, without limitation, five minutes.

Before executing the assessment tool, the computing device 206 may receive input from the education institution. The assessment engine 210 may modify the assessment tool based on the received input. By way of example, and without limitation, a user associated with an educational institution may transmit, via a user interface 216a displayed by a first computing device 202a, input. The input may be associated with one or more educational programs offered by the educational institution. The assessment engine 210 may customize the assessment tool for applicants to the educational institution. In this way, the questions of the assessment tool may be tailored to a specific institution; for example, and without limitation, the questions may be tailored to provide a mission-centered assessment for an educational institution. As another example, the questions of the assessment tool may include questions that are aligned with one or more initiatives of the educational institution.

The method 100 includes identifying, by an analysis engine executed by the computing device, at least one risk factor for non-persistence by the applicant (104). The analysis engine 212 may receive output associated with the applicant from the assessment engine 210. The analysis engine 212 may analyze one or more responses by an applicant to one or more questions presented by execution of the assessment tool. The analysis engine 212 may benchmark one or more responses against a nationally normed sample of individuals who completed one or more courses of study and/or received a college degree. The analysis engine 212 may benchmark one or more responses against a nationally normed sample of individuals who did not complete one or more courses of study and/or did not receive a college degree. The analysis engine 212 may assign a score to the output. The analysis engine 212 may analyze the received output to identify the at least one risk factor.

The method 100 includes identifying, by the analysis engine, a likelihood of success by the applicant in completing at least one requirement of an educational institution (106). The at least one requirement may be a requirement for completing a course of study in an educational program offered by the educational institution and to which the applicant is applying. The at least one requirement may include, without limitation, a requirement to complete a number of credits, a requirement to take one or more core courses required for the course of study, a requirement to complete one or more extracurricular activities while maintaining a certain grade point average, a requirement to satisfy one or more courses in a curriculum set by the educational institution or a national association or other standard setting body, a requirement for one or more meetings with members of a department overseeing a course of study, a requirement for one or more elective courses in addition to one or more core courses, a requirement for one or more publications (e.g., theses, peer reviewed articles, or other written requirements), a requirement for one or more oral communications assignments, or any requirement specified by the educational institution for completing a course of study and/or receiving a degree from the educational institution.

The analysis engine 212 may identify a likelihood of success by the applicant in completing at least one requirement of an educational institution. The analysis engine 212 may identify the likelihood of success responsive to analysis of output received from the assessment engine 210. The analysis engine 212 may identify a likelihood of retention by the educational institution of the applicant for a specified duration of time, such as for example, time required to complete a two- or four-year degree program. As with identifying the risk factors, to identify the likelihood of success, the analysis engine 212 may analyze one or more responses by an applicant to one or more questions presented by execution of the assessment tool. To identify the likelihood of success, the analysis engine 212 may benchmark one or more responses against a nationally normed sample of individuals who completed one or more courses of study and/or received a college degree. To identify the likelihood of success, the analysis engine 212 may benchmark one or more responses against a nationally normed sample of individuals who did not complete one or more courses of study and/or did not receive a college degree.

The analysis engine 212 may determine that the applicant satisfies a threshold level of success based upon a determination that the applicant exceeds a threshold score for the non-cognitive variable. The analysis engine 212 may execute functionality for determining, based on one or more responses given by the applicant to the assessment tool, one or more characteristics in common between the applicant and previous respondents to the assessment. By way of example, the analysis engine 212 may determine the likelihood of success for an applicant by determining that because the applicant has a threshold number of characteristics in common with a previous applicant who did complete a course of study at an educational institution and did receive a college degree, the applicant is also likely to succeed—or that because the applicant has a threshold number of characteristics in common with a previous applicant who completed one or more recommended actions and went on to complete a course of study at the same educational institution the applicant is applying to (or one with substantial similarities) and did go on to receive a college degree, the present applicant is also likely to succeed in completing the course of study and/or receiving a college degree.

The analysis engine 212 may determine that the applicant satisfies a threshold level of success based upon a determination that the applicant exceeds a threshold score assigned to a combination of a non-cognitive variable with a cognitive variable. For example, the analysis engine 212 may retrieve or otherwise access data that provides information about a cognitive variable (for example, as assessed by standardized testing or other metric) and then combine a score associated with the cognitive variable with a score associated with the non-cognitive variable to provide a more accurate assessment of the likelihood of success by the applicant in completing at least one requirement of the educational institution.

The method 100 includes identifying, by the analysis engine, at least one action to recommend for execution, execution of the at least one action satisfying a threshold level of likelihood of improving the likelihood of success (108). The risk factors determine the recommended actions. The analysis engine 212 may identify one or more actions to recommend for a particular action in order to mitigate the impact of one or more risk factors on the applicant's likelihood of success. Actions may take a wide variety of forms, including without limitation, actions based on providing applicants with support of a variety of types to increase a likelihood of success for the applicant. By way of example and without limitation, recommended actions may include taking certain courses (academic or otherwise); assignment to counselors, mentors, or other advisors having one or more skills that will support the applicant's success; taking steps prior to classroom experiences (e.g., scheduling wake-up calls or receiving support in completing assignments on a timely basis); receiving counseling regarding how to interact with others, how to communicate, and other skills relating to interpersonal interactions; receiving counseling regarding mental, physical, and/or emotional health, including therapy, nutritional guidance, sleep-related guidance, and other health-related guidance; and so on. As an additional example and without limitation, recommended actions may include actions to remediate low adjustment (e.g., psychological support, mindfulness practice, meditation practice, cognitive framing training, self-awareness, and emotional expression training), low ambition (e.g., clearly assigned tasks, explanations of expectations on assignments, growth mindset training), low sociability (assistance with engaging during class, guidance as to how to identify and connect with other students formally and informally), low interpersonal sensitivity (e.g., interpersonal and communication coaching and empathy coaching), low prudence (assistance with keeping track of assignments and deadlines, multiple incremental due dates, time management assistance, professionalism training), low inquisitiveness (guidance regarding selection of courses of studies that meet their strengths such as studies that benefit from skills in memorization or repetition and avoidance of studies that rely on open-ended coursework requiring increased creativity and investment of time and energy to develop self-paced projects and deadlines), and low learning approach (individualized instruction, connecting lecture materials with student goals, and providing concrete, practical applications of concepts).

The analysis engine 212 may generate a recommendation for a representative of the educational institution to interact with the applicant to review recommendations and develop a specific plan for that particular applicant that will assist the applicant in adjusting non-cognitive variables (including, without limitation, making lifestyle adjustments) to mitigate risk factors that threaten retention and to increase a likelihood of success of the applicant.

The method 100 includes providing, by the analysis engine, to the educational institution, the identified at least one action (110). Analysis engine 212 may generate a report or plan customized for each applicant and detailing one or more steps for the applicant to take (e.g., as part of a specific educational program and/or contingent to acceptance into the educational institution). By identifying risk factors that impact an applicant's likelihood of success and by doing so early (e.g., during the application process and/or periodically throughout a course of study), execution of the methods and systems described herein may provide more time in which to mitigate those risk factors, to increase self-awareness, and to set and execute goals that impact and optimize outcomes. The applicant may use the report or other output to design support and services that increase their likelihood of success.

In some embodiments, the methods and systems described herein are executed multiple times. By way of example, the methods may execute to generate and provide an identified at least one action for at least one applicant to an educational institution. However, the methods may also be executed again when the applicant has begun a course of study at the educational institution and an updated report may be generated with updated recommendations for actions to implement that may impact the applicant's likelihood of success. The methods and systems may be executed for not just one applicant but for a plurality of applicants and/or students, including, by way of example, for one or more classes or other cohorts and reports may be provided for actions to take to improve the combined likelihood of success of a plurality of students (e.g., former applicants).

The assessment engine 210 may be provided as a software component. The assessment engine 210 may be provided as a hardware component. The computing device 206 may execute the assessment engine 210.

The analysis engine 212 may be provided as a software component. The analysis engine 212 may be provided as a hardware component. The computing device 206 may execute the analysis engine 212.

The user interface engine 214 may be provided as a software component. The user interface engine 214 may be provided as a hardware component. The computing device 206 may execute the user interface engine 214.

The computing device 206 may include or be in communication with the database 220. The database 220 may store data related to non-cognitive variables. The database 220 may store data related to application data provided by or otherwise made accessible by one or more educational institutions. The database 220 may store data including one or more rules for scoring variables (cognitive and/or non-cognitive variables) associated with applicants to determine likelihoods of success. The database 220 may store data including one or more rules for associating scores of non-cognitive variables with recommendations for actions to take to increase a likelihood of success by at least a threshold amount. The database 220 may be an ODBC-compliant database. For example, the database 220 may be provided as an ORACLE database, manufactured by Oracle Corporation of Redwood Shores, CA. In other embodiments, the database 220 can be a Microsoft ACCESS database or a Microsoft SQL server database, manufactured by Microsoft Corporation of Redmond, WA. In other embodiments, the database 220 can be a SQLite database distributed by Hwaci of Charlotte, NC, or a PostgreSQL database distributed by The PostgreSQL Global Development Group. In still other embodiments, the database 220 may be a custom-designed database based on an open source database, such as the MYSQL family of freely available database products distributed by Oracle Corporation of Redwood City, CA. In other embodiments, examples of databases include, without limitation, structured storage (e.g., NoSQL-type databases and BigTable databases), HBase databases distributed by The Apache Software Foundation of Forest Hill, MD, MongoDB databases distributed by 10Gen, Inc., of New York, NY, an AWS DynamoDB distributed by Amazon Web Services and Cassandra databases distributed by The Apache Software Foundation of Forest Hill, MD. In further embodiments, the database 120 may be any form or type of database.

Although, for ease of discussion, the assessment engine 210, the analysis engine 212, the user interface engine 214, and the database 220 are described in FIG. 2 as separate modules, it should be understood that this does not restrict the architecture to a particular implementation. For instance, these components may be encompassed by a single circuit or software function or, alternatively, distributed across a plurality of computing devices.

The system 200 may include non-transitory, computer-readable medium comprising computer program instructions tangibly stored on the non-transitory computer-readable medium, wherein the instructions are executable by at least one processor to perform each of the steps described above in connection with FIG. 1.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

Although terms such as “optimize” and “optimal” may be used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

In some embodiments, the system 100 includes non-transitory, computer-readable medium comprising computer program instructions tangibly stored on the non-transitory computer-readable medium, wherein the instructions are executable by at least one processor to perform each of the steps in the methods described.

Having described certain embodiments of methods and systems for generating recommendations for actions to be executed to improve non-cognitive metrics impacting likelihood of requirement completion, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for generating recommendations for actions to be executed to improve non-cognitive metrics impacting likelihood of requirement completion comprising:
executing, by a computing device, an assessment tool for assessing at least one non-cognitive variable of an applicant;
identifying, by an analysis engine executed by the computing device, at least one risk factor for non-persistence by the applicant;
identifying, by the analysis engine, a likelihood of success by the applicant in completing at least one requirement of an educational institution;
identifying, by the analysis engine, at least one action to recommend for execution, execution of the at least one action satisfying a threshold level of likelihood of improving the likelihood of success; and
providing, by the analysis engine, to the educational institution, the identified at least one action.

2. The method of claim 1 further comprising:
before executing the assessment tool, receiving, by the computing device, input from the education institution; and
modifying, by the computing device, the assessment tool responsive to the received input.

3. The method of claim 1 further comprising:
analyzing, by the analysis engine, the at least one risk factor; and
identifying, by the analysis engine, the likelihood of success based upon the analyzing of the at least one risk factor.

4. The method of claim 1 further comprising:
scoring, by the analysis engine, an output of the assessment tool; and
determining, by the analysis engine, that the applicant satisfies a threshold level of success based upon exceeding a threshold score for the non-cognitive variable.

5. The method of claim 1 further comprising:
scoring, by the analysis engine, an output of the assessment tool; and
determining, by the analysis engine, that the applicant satisfies a threshold level of success based upon exceeding a threshold score for the cognitive variable.
